(19) United States
(12) Patent Application Publication
(10) Pub. No.: US 2024/0119863 A1
(43) Pub. Date: Apr. 11, 2024

(54) SPANISH LANGUAGE TEACHING DEVICE AND METHOD

(71) Applicant: Jason Pilkenton, Rochester, NY (US)

(72) Inventor: Jason Pilkenton, Rochester, NY (US)

(21) Appl. No.: 17/961,248

(22) Filed: Oct. 6, 2022

(51) Int. Cl. G09B 19/06; G09B 5/02

(52) U.S. Cl. CPC G09B 19/06; G09B 5/02

(57) ABSTRACT

A computer readable medium storing a program causing a computer to execute a display process for teaching Spanish language, the display process includes: arranging a series of slides including contents in a progressively more expressive manner, each slide depicting at least a portion of a binary tree, wherein at least one later slide of two consecutive slides of the series of slides includes at least a pair of child nodes of a parent node of an earlier slide of the two consecutive slides; and associating a first button to a first function of the display process, the first button is configured to advance a display of an earlier slide to a display of a later slide and associating a second button to a second function of the display process, the second button is configured to roll back a display of a later slide to a display of an earlier slide.

### 1. THE FIELD OF THE INVENTION

The present invention relates to a Spanish language teaching device and method that focuses on gradual but memorable presentation of rules related to construction of sentences. More specifically, the present invention is directed to a Spanish language teaching device and method that focuses on gradual but memorable presentation of rules related to construction of sentences that is graphical and color-coded.

### 2. BACKGROUND ART

Traditionally, the Spanish language is taught wholistically, at the same time, where memorization is used as the fundamental foundation. This technique is fraught with numerous disadvantages due to the overwhelming number of aspects in the Spanish language learning process which need to be memorized simultaneously. This causes numerous Spanish language learners to fail in mastering the language and hence fail in becoming an effective Spanish language communicator or give up learning the language altogether due to the impression of new learners the language lacks structures in its sentence construction. Existing Spanish language construction techniques further lack the concept of introducing new information in a sequential “bite-size” manner in an order that facilitates the learning process. A new learner is given an overwhelming and ever-changing amount of new information or “moving parts” to internalize.

There exists a need for a Spanish language teaching device and method that can provide a systematic and simple mechanism for a Spanish language learner to follow.

### SUMMARY OF THE INVENTION

In accordance with the present invention, there is provided a computer program for executing a display process configured for aiding a user in constructing a sentence in Spanish language, the computer program adapted to execute on a system including a processor, and a non-transitory machine-readable storage medium instructions that when executed, cause the processor to execute a display process including:
(a) arranging a series of slides including contents in a progressively more expressive manner, each slide depicting at least a portion of a binary tree, wherein at least one later slide of two consecutive slides of the series of slides includes at least a pair of child nodes of a parent node of an earlier slide of the two consecutive slides; and
(b) associating a first button to a first function of the display process, the first button is configured to advance a display of an earlier slide to a display of a later slide and associating a second button to a second function of the display process, the second button is configured to roll back a display of a later slide to a display of an earlier slide,
   whereby a user of the display process can look up at least two child nodes as related to a parent node on an earlier slide.

In one embodiment, the binary tree includes two nodes characterized by a noun followed by a verb at a base level. In one embodiment, the binary tree includes two nodes characterized by an infinitive form and a conjugated form based on the verb. In one embodiment, the binary tree includes two nodes characterized by a gender and a number based on the noun. In one embodiment, the binary tree includes two nodes characterized by a masculine form and a feminine form based on the gender. In one embodiment, the binary tree includes two nodes characterized by a singular form of the noun and a plural form of the noun based on the number. In one embodiment, the binary tree includes two nodes characterized by an article and an adjective attached to the noun. In one embodiment, a noun sub-sentence is configured to be formed with the adjective agreeing with the noun in the gender and the number. In one embodiment, the article includes two nodes characterized by an indefinite article and a definite article. In one embodiment, a noun sub-sentence is configured to be formed according to a string selected from the group consisting of the indefinite article and the adjective agreeing with the noun in the gender and the number and the definite article and the adjective agreeing with the noun in the gender and the number. In one embodiment, the noun sub-sentence is substituted with a subject pronoun. In one embodiment, a verb ending of the verb is determined based on the subject pronoun. In one embodiment, the binary tree includes two nodes characterized by a singular form and a plural form based on the subject pronoun.

In accordance with the present invention, there is further provided a computer readable medium storing a program causing a computer to execute a display process for teaching Spanish language, the display process including:

(a) arranging a series of slides comprising contents in a progressively more expressive manner, each slide depicting at least a portion of a binary tree, wherein at least one later slide of two consecutive slides of the series of slides comprises at least a pair of child nodes of a parent node of an earlier slide of the two consecutive slides; and

(b) associating a first button to a first function of the display process, the first button is configured to advance a display of an earlier slide to a display of a later slide and associating a second button to a second function of the display process, the second button is configured to roll back a display of a later slide to a display of an earlier slide,

whereby the user can look up elements of each of at least two child nodes as related to a parent node on an earlier slide.

An object of the present invention is to provide a teaching tool to aid a learner of Spanish language in mastering proper Spanish grammar and sentence construction.

Another object of the present invention is to allow a narrow focus of grammatical construction of the Spanish language at any stage in the language learning process.

Another object of the present invention is to allow a narrow focus of grammatical construction of the Spanish language by using a binary tree method at any stage in the language learning process.

Another object of the present invention is to allow a narrow focus of grammatical construction of the Spanish language, to the exclusion of all other aspects of grammar sentence structure, at any stage in the language learning process, thereby allowing a learner to focus on mastering each binary step of the learning process.

Another object of the present invention is to provide a structure which allows a learner to minimize the extent of memorization required to construct a grammatically correct sentence, verbal or written.

Another object of the present invention is to instill confidence in the part of a learner to further develop his or her Spanish language skills due to the adherence to a trusted structure in grammatically correct sentence structure.

Another object of the present invention is to provide a structure which allows a learner to master the Spanish language in a “bite-size” manner while reducing the amount of memorization overload required in conventional language learning techniques.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram depicting an output display indicating an initial step displayed to show two child nodes required to build and master the Spanish language.

FIG. 2 is a diagram depicting an output display showing the alphabet node further divided in two nodes.

FIG. 3 is a diagram depicting an output display showing two child nodes of a sentence.

FIG. 4 is a diagram depicting an output display showing two child nodes of a noun.

FIG. 5 is a diagram depicting an output display showing two child nodes of the gender node.

FIG. 6 is a diagram depicting an output display showing two child nodes of the number node.

FIG. 7 is a diagram depicting an output display showing an article node and an adjective node attached to a noun.

FIG. 8 is a diagram depicting an output display showing two child nodes of the adjective node of a noun.

FIG. 9 is a diagram depicting an output display showing a step having been applied to form a noun sub-sentence.

FIG. 10 is a diagram depicting an output display showing two child nodes of the article node of a noun.

FIG. 11 is a diagram depicting an output display showing another step having been applied to form another noun sub-sentence.

FIG. 12 is a diagram depicting an output display showing the consolidation of the noun sub-sentences of FIGS. 9 and 11.

FIG. 13 is a diagram depicting an output display showing the representation of the noun and its article and adjective using a subject pronoun.

FIG. 14 is a diagram depicting an output display showing two child nodes of the subject pronoun.

FIG. 15 is a diagram depicting an output display showing two child nodes of the verb.

FIG. 16 is a diagram depicting an output display showing two child nodes of the verb, one of which is a more expressive form of one of the two child nodes compared to the child node in FIG. 15.

FIG. 17 is a diagram depicting an output display showing determination of verb endings based on a subject pronoun.

FIG. 18 is a diagram depicting an output display showing a step having been applied to form a complete sentence.

FIG. 19 is a block diagram depicting one embodiment of the hardware for carrying out the present system.

### PARTS LIST

2—display
4—button for advancing to next slide
6—button for retreating to previous slide
8—listing of available slides
10—noun part of a sentence
12—verb part of a sentence
14—gender designation
16—number designation
18—masculine designation
20—feminine designation
22—singular designation
24—plural designation
26—article designation
28—adjective designation
30—definite designation
32—indefinite designation
34—representation of a sentence
36—pronouns
38—singular pronouns
40—plural pronouns
42—infinitive form of verb
44—conjugated form of verb
46—subject pronoun verb ending chart
48—input device
50—output device
52—internet
54—web server/s
56—central repository
58—monitoring device

### Particular Advantages of the Invention

The present invention is a unique and unprecedented approach to Spanish language mastery. Some key characteristics include the ordering of the process and the exclusive characteristic of the Spanish language, i.e., Spanish grammar can be broken down into exactly two choices, uncovered by the Applicant. The present device and method begin with the most basic grammatical structure and concept of the Spanish language grammar. As one must move from the most basic form and concept to ever increasing concepts, the process forces a learner to master a concept before moving on to the next level which builds on the previously mastered concept/s. As the present method progresses, a learner masters steps by systematically moving down the left side of the layout of the present device. Once reaching the base on the left side of the layout, the learner then moves to the center of the layout, and finally the right side of the layout. Once the materials of the present device and method have been mastered, a sentence can be formulated via the base of the layout from left to right, as it was learned.

The present device and method use color for differentiating the two major parts of a complete sentence, therefore indicating that the two major parts are diverse in their own construction. For instance, a noun uses an “agreement,” and a verb uses conjugation. In contrast, traditional Spanish language learners are taught concurrently without any concept of prioritizing the order or the amount of new information conveyed by traditional teaching techniques.

The present device and method force a learner to traverse a learning process in a sequential “bite-size” manner in an order that facilitates the learning process.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

As used in the present figures, a number enclosed in circle represents a step. For instance, a portion of a figure having a number 1 enclosed in a circle means that the portion of the figure is associated with step 1. A portion of a figure can be associated with more than one step.

The present device and method for teaching the Spanish language are premised on a binary tree and a plurality of steps with each step including parts/things to know. This “limited knowledge process” allows for specific targeting of information and concepts more readily cognitively understood and retained. Thus, mastery level achievement in the Spanish language is facilitated. This format of learning reduces “mental overhead” and consequently, pullback by a learner. Additionally, this format of learning reduces the urge to resort to traditional overloading memorization. As one masters a subject, his or her way of internalizing new information relative to the subject will change. If one simply memorizes information, minimal change in understanding or view of new information occurs. More likely, an overloading of processing of new information will occur and a small amount of learning will be retained. In order to effectively and efficiently learn the Spanish language, a learner must focus on mastery, as opposed to the traditional memorization tactics. By using a “binary tree” like method of breaking the language down to just two things that one needs to know to move on to the next step, a learner is able to master the Spanish grammatical framework, piece by piece. Therefore, each step will have two numbers or parts that must be mastered prior to moving to the next step. For information to have maximum value, it needs to be timely and relevant. The right information, e.g., relevance, at the right time, e.g., timeliness, has value. Without timeliness and relevance, the value diminishes drastically. The present method also has the proper blend of spacing of interweaving of learning of Spanish skills to maximize mastery.

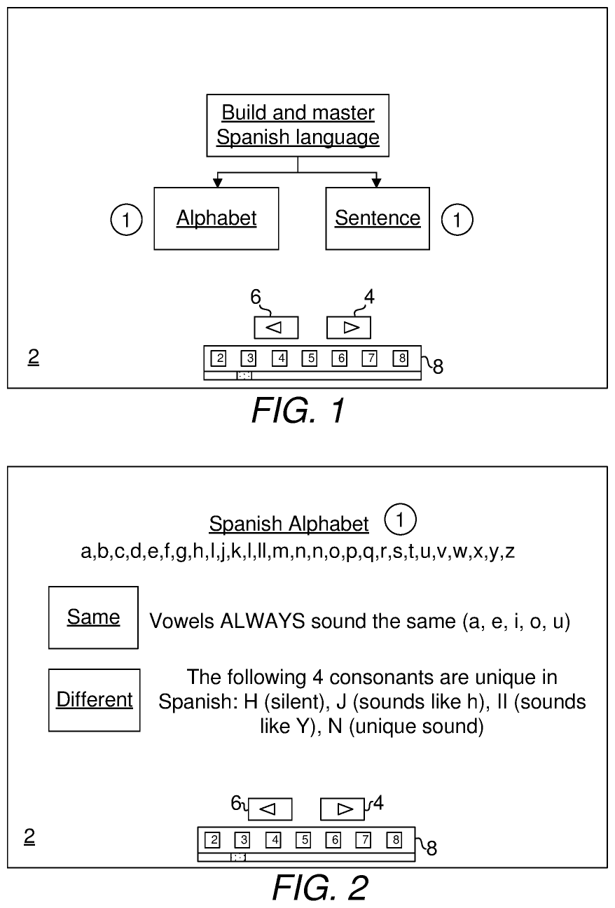

FIG. 1 is a diagram depicting an output display 2 indicating an initial mechanism displayed to show two child nodes required to build and master the Spanish language. FIG. 2 is a diagram depicting an output display 2 showing the alphabet node further divided in two nodes. An output display, as used herein, refers to a computer display screen or projection where the display is digitally manipulated to allow slides or images to be displayed and altered with an interaction with the display or a control device which takes an input of the user, e.g., by pressing a button on the screen or by pressing a button of a remote device to alter the display by advancing from one image to the next or retreat to the previous image or to display any image selected by the user. A button 4 for advancing to the next image is made available for interface with the user. Another button 6 is provided to revert to allow the user to revert to the previous image. A listing 8 of available slides is provided to allow the user to quickly select the desired image to be displayed. By allowing the user to select an image at will or by allowing two consecutive images to be displayed consecutively on the display screen 2, the user can at least visually detect the differences between the two consecutive images such that the child nodes on a latter image can be recognized and committed to memory if necessary. As the changes between two consecutive slides are generally obvious and minor, the user can more readily grasp the new materials taught in a latter image without being overwhelmed.

Regarding FIG. 1, in order to build and master the Spanish language, one needs two things, i.e., alphabet and a sentence. With the use of a present device and method, Spanish language skills are built instead of being purely memorized. In order to build something, one needs raw materials for building and to know what is being built, i.e., the final product. The alphabet is akin to materials and a sentence is akin to a goal or end product. The alphabet include a, b, c, d, e, f, g, h, I, j, k, I, II, m, n, n, o, p, q, r, s, t, u, v, w, x, y and z. Referring to FIG. 2, there are two main ideas to know about the Spanish alphabet. First, vowels always sound the same as English vowels. Second, four letters sound different than English. Regarding the consonants that sound different in English, the Applicant further provides a way to help memorize this simple rule by providing this mnemonic: “Why are these Gold? These are Gold because they sound “rare” and are important to assimilating Spanish phonetics properly. You are “golden” if you can make these sounds.” Further, a diagram depicted herein may be referred to as a “pyramid” as the binary tree is depicted with one or more sets of child nodes relating to their parent node.

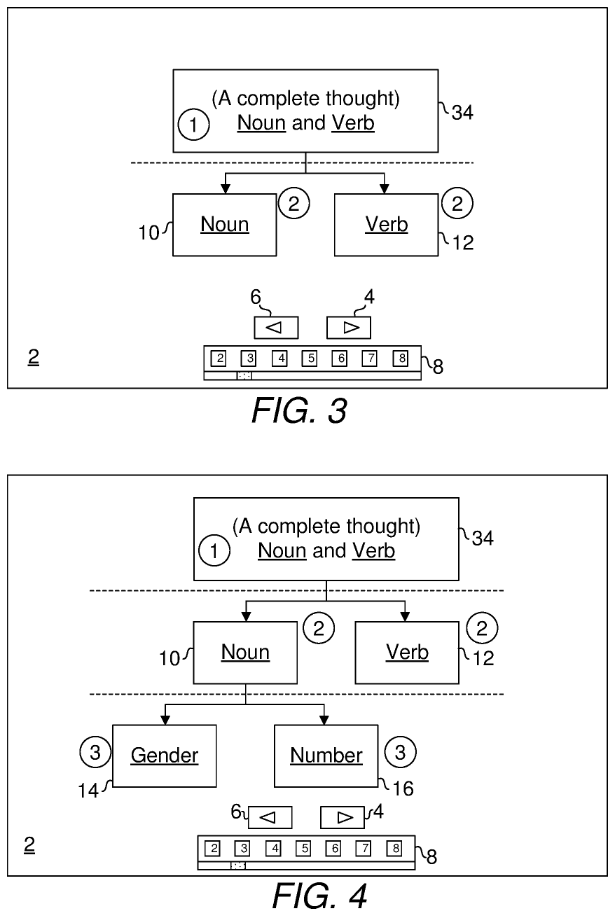

In step 1 as shown in FIG. 3, it is important to know what to build. A sentence is a complete thought. In order to be a complete thought, a sentence must have two things: a noun and a verb. A sentence can be as simple as a two-word sentence, e.g., “John talks,” and “Juan habla,” etc. In one embodiment, in order to further aid one in memorizing relationships of any portions of the present display process, different colors and relationships of colors are used. For instance, in a color spectrum, as a color purple is the result of combining a color blue and a color red, a parent node can be colored purple while its child nodes can be colored blue and red, respectively, to represent the components making up the parent node. Applying this example to the nodes shown in FIG. 3, the representation of a sentence 34 can be colored purple and the noun part 10 of a sentence can be colored blue and the verb part 12 of a sentence can be colored red. Referring again to FIG. 3, in step 2, a Spanish sentence is composed of a noun part 10 and verb part 12 as in English. A noun can be a person, a place or a thing. A verb is an action word.

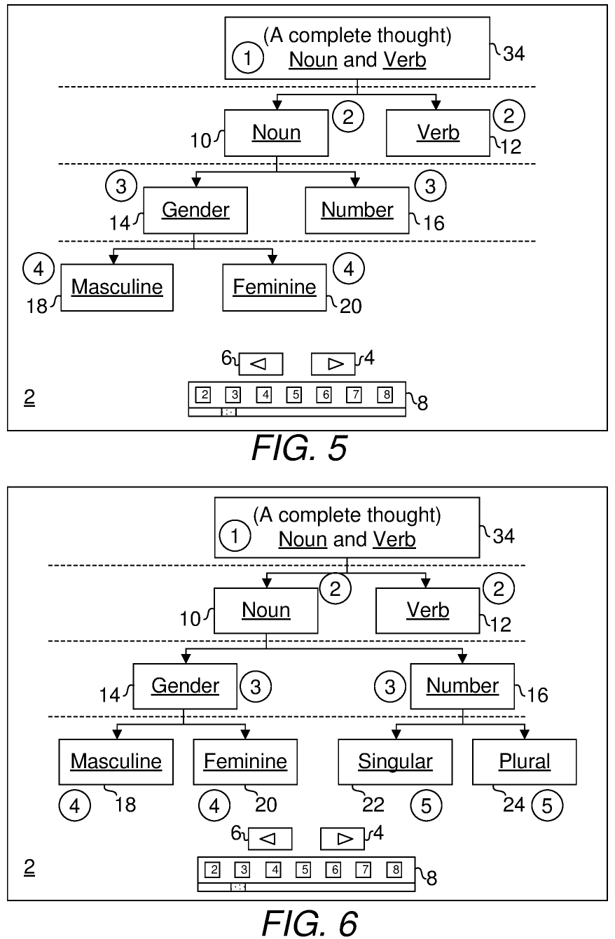

In step 3 as shown in FIG. 4, there are just two things one has to know about a noun, i.e., gender 14 and number 16. Gender includes masculine, e.g., a boy or feminine, e.g., a girl and number includes singular, e.g., one or plural, e.g., more than one. As most sentences, especially a traditional, basic sentence, begins with a noun, followed by the verb that the noun performs, the noun side is presented first to a learner. Further, noun mastery is more finite. That is, the information and skills required are more finite and contained. Verbs are far more intricate, in depth, vast and have many levels/layers of difficulty. The noun process should be started first because a definite or an indefinite article and an adjective agreeing with a noun in gender and number can be mastered throughout the pyramid through repetition to complete the diagrams herein throughout, thus leaving only irregular nouns (not disclosed herein) to master. FIG. 5 is a diagram depicting an output display 2 showing two child nodes of the gender node, i.e., masculine 18 and feminine 20 forms. In step 4 as shown in FIG. 5, there are just two things to know about gender, e.g., boy or “chico” which ends in the letter “o” and “chica” which ends in the letter “a.”

FIG. 6 is a diagram depicting an output display 2 showing two child nodes of the number node, i.e., singular 22 and plural 24 forms. In step 5 as shown in FIG. 6, there are just two things to know about number, e.g., only one for the singular 22 form or more than one for the plural 24 form. For a plural word ending in a vowel, a letter “s” is simply added to the end of a word, e.g., “chica” becomes “chicas” and “professor” becomes “profesores.”

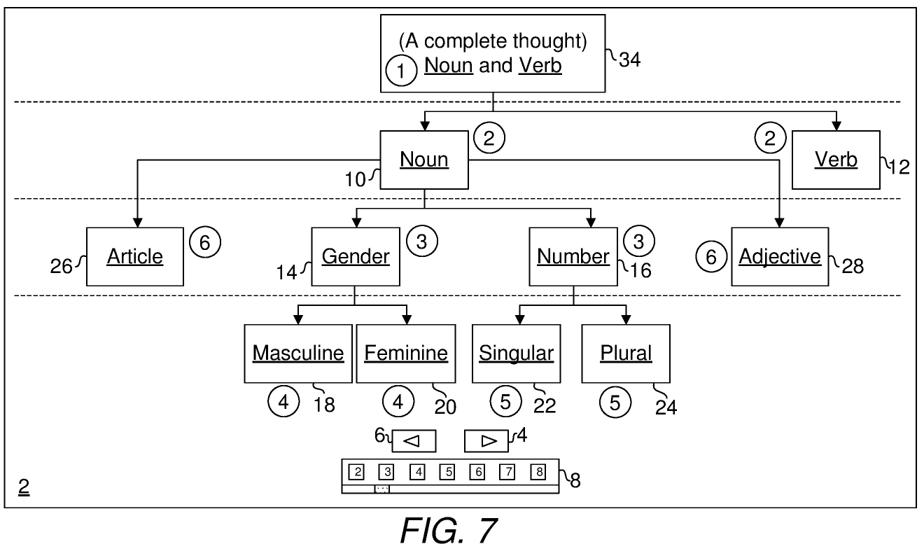

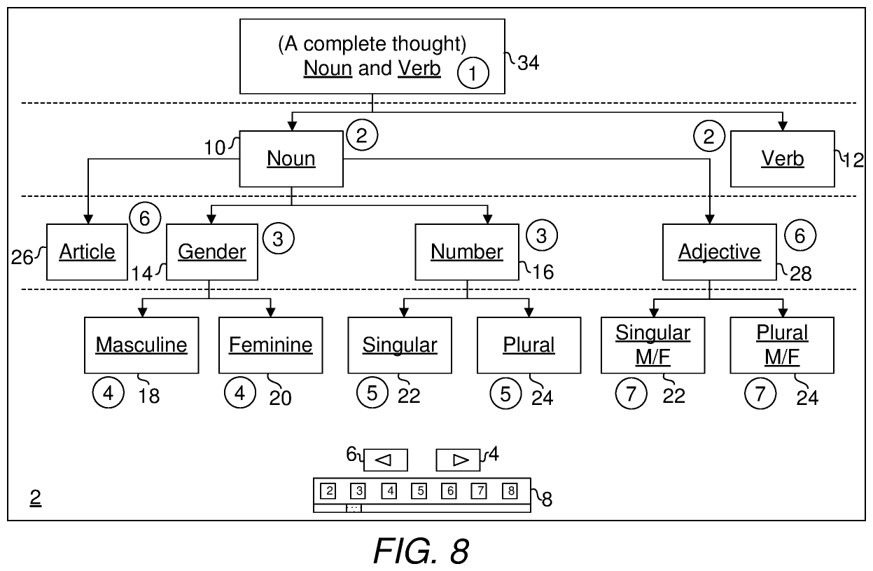

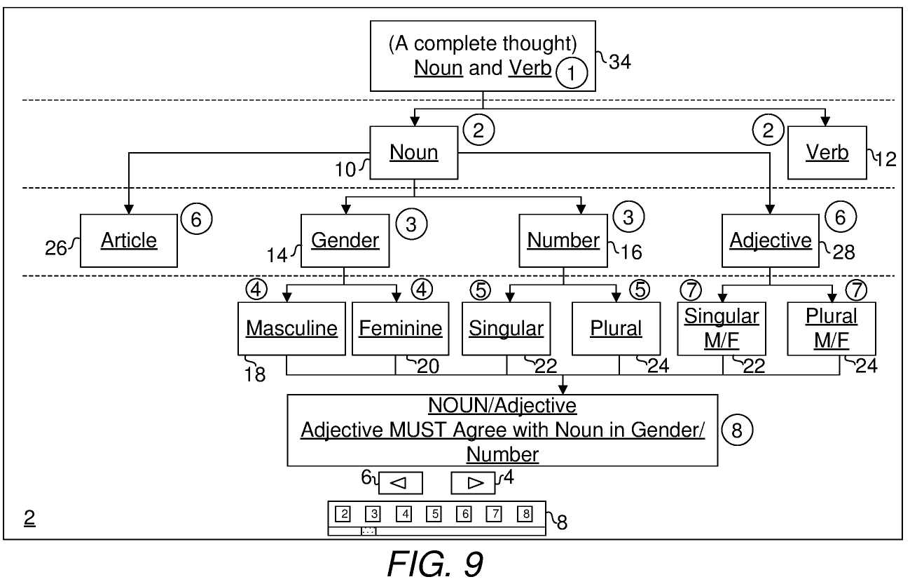

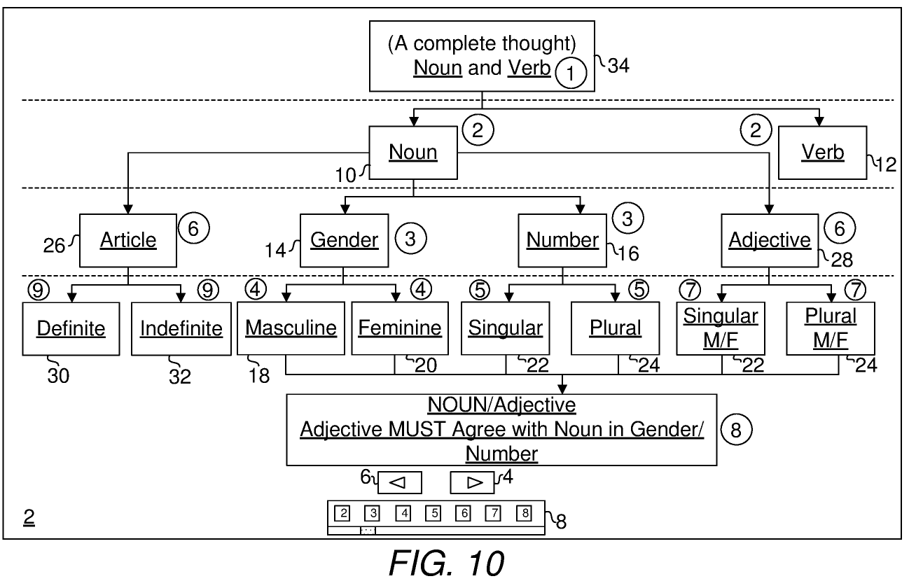

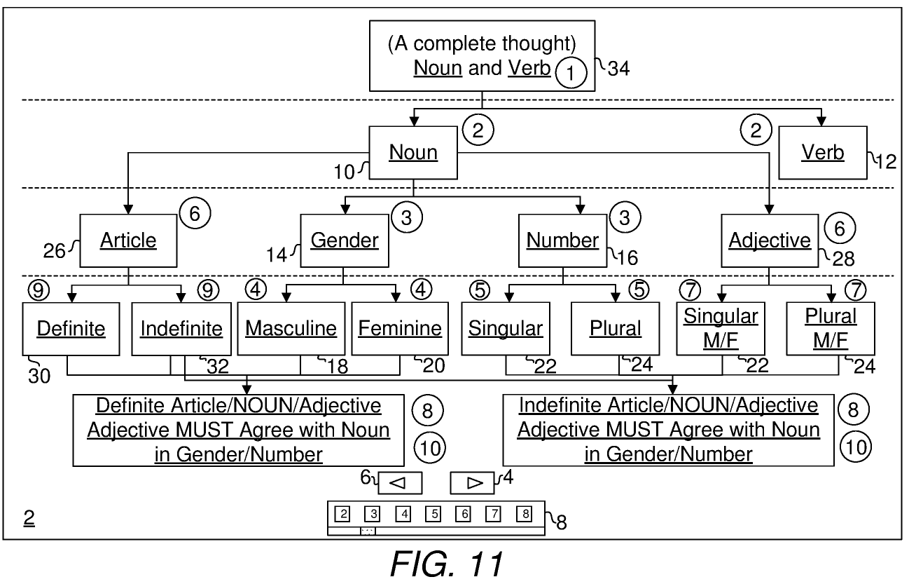

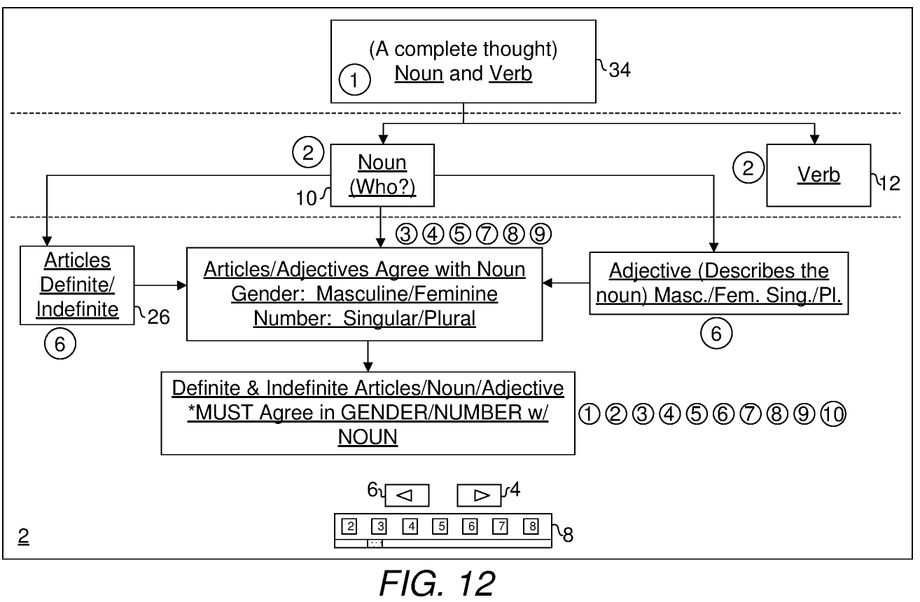

FIG. 7 is a diagram depicting an output display showing an article node 26 and an adjective node 28 attached to a noun 10 in step 6. Articles and adjectives are useful for describing the noun 10. FIG. 8 is a diagram depicting an output display showing two child nodes of the adjective node 28 of a noun 10, i.e., a gender node 14 and a number node 16, in step 7. FIG. 9 is a diagram depicting an output display 2 showing a step, i.e., step 8, having been applied to form a noun sub-sentence. There are two big ideas with the first being that the adjectives must agree in gender and the second being that the adjectives must agree in number with the noun 10. FIG. 10 is a diagram depicting an output display 2 showing two child nodes of the article node 26 of a noun 10 in step 9. There are two types of articles, i.e., definite articles and indefinite articles. The definite article in English is the word “the.” Definite articles in Spanish can be “el,” “la,” “los,” and “las.” Indefinite articles in English are words “a,” and “some.” Indefinite articles in Spanish can be “un,” “una,” “unos,” and “unas.” The synonym for “definite” is specific. FIG. 11 is a diagram depicting an output display 2 showing another step having been applied to form another noun sub-sentence as in step 10. FIG. 12 is a diagram depicting an output display 2 showing the consolidation of the noun sub-sentences of FIGS. 9 and 11. These agreements must be mastered in order to be an effective or efficient Spanish language learner. In step 10 or the second of the two big ideas, definite articles 30 or indefinite articles 32, as do adjectives, must agree in gender and number with noun. This completes the noun 10 node of the pyramid.

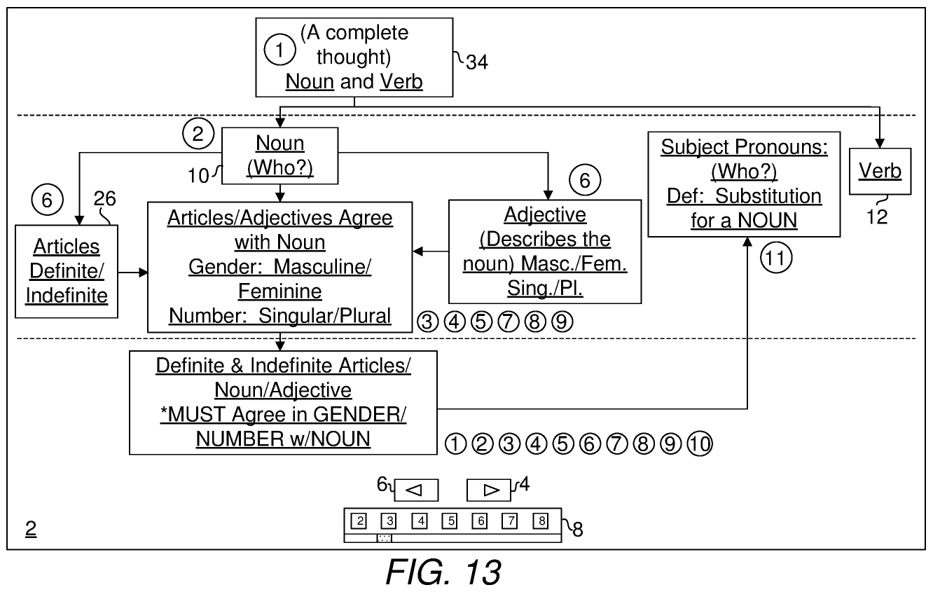

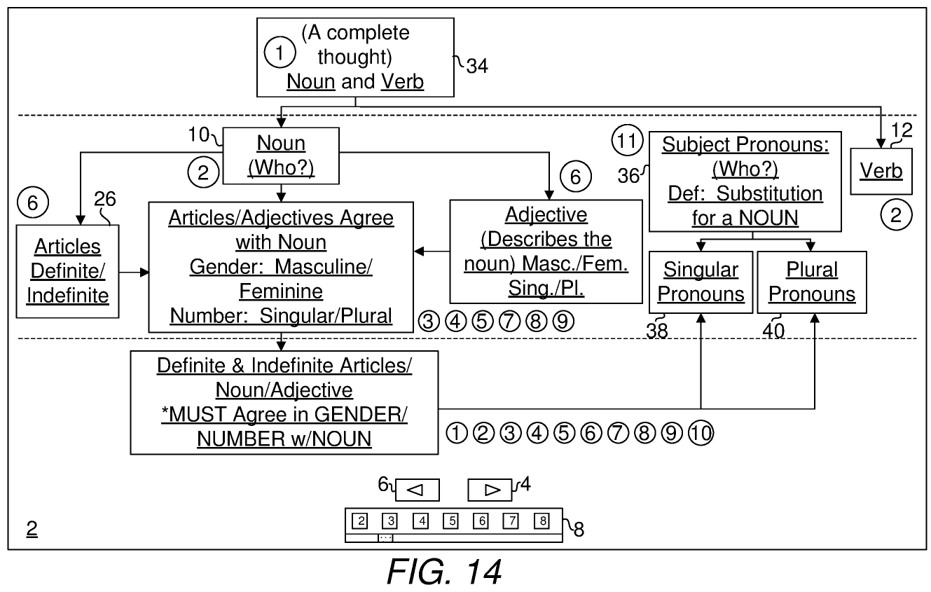

FIG. 13 is a diagram depicting an output display 2 showing the representation of the noun 10 and its article 26 and adjective 28 using a subject pronoun 36 in step 11. A “subject” in a sentence is an easier, simpler and more convenient and common way to express the noun and its articles/adjectives and therefore a subject pronoun can be used to substitute the sub-sentences. By using a subject pronoun, the entire noun side of the pyramid can be substituted with just one word. FIG. 14 is a diagram depicting an output display 2 showing two child nodes, i.e., singular 38 and plural 40, of the subject pronoun 36. The subject pronouns can be first-person, second-person or third-person pronouns.

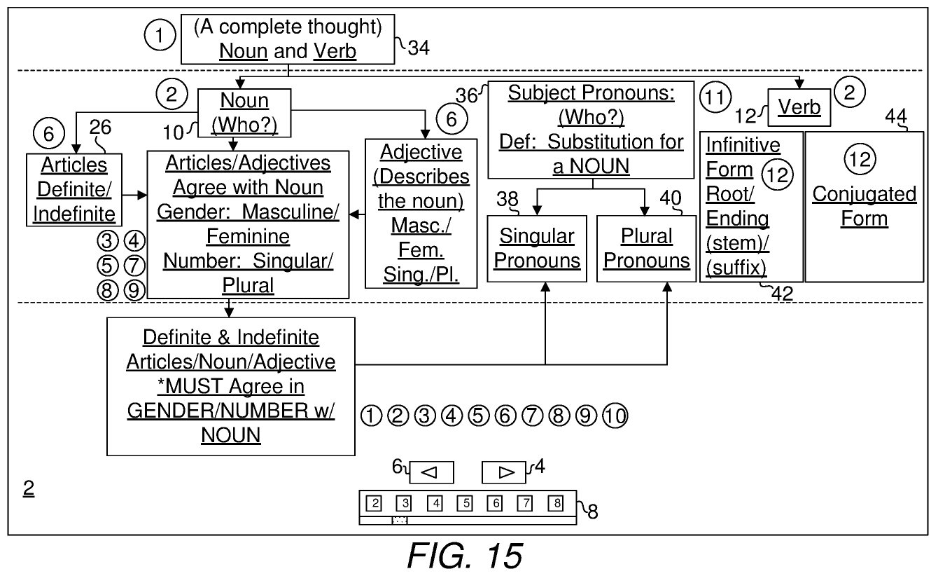

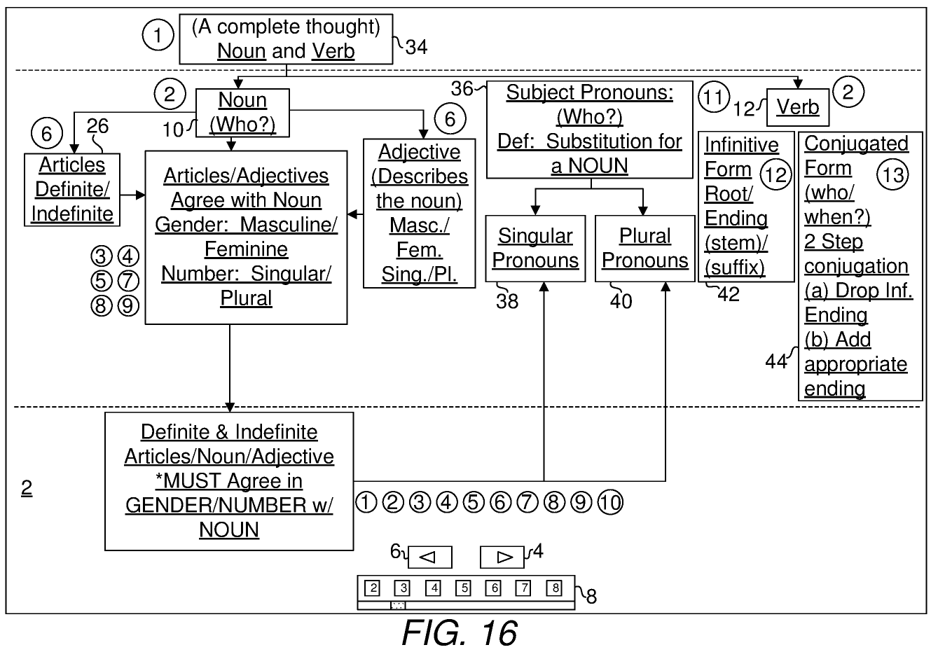

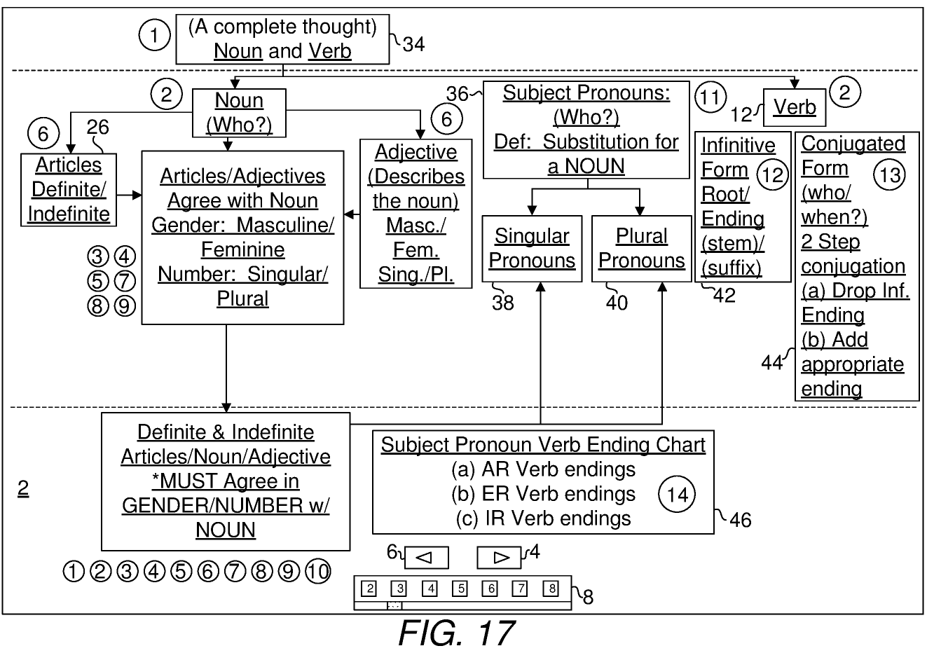

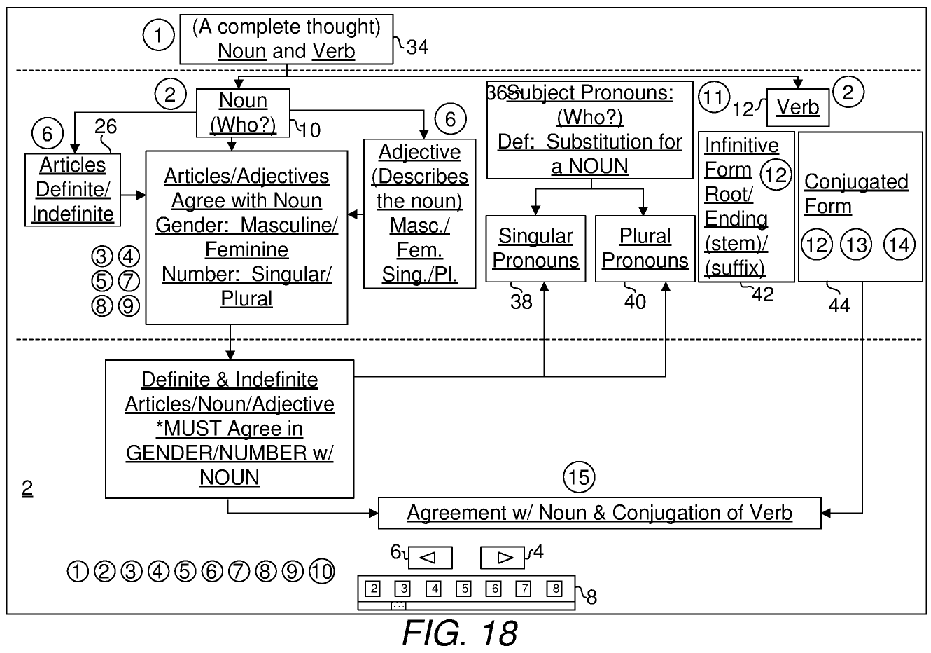

FIG. 15 is a diagram depicting an output display 2 showing two child nodes of the verb 12 in step 12. There are two forms of Spanish verbs, i.e., the infinitive 42 form and the conjugated 44 form. In step 12, there are only two things that one needs know about infinitive verbs. First, there are two parts to a verb, i.e., a stem or root and a suffix or ending. Second, there are three types of verbs in the infinitive form, i.e., ones with “ar,” “er,” and “ir” suffix or ending. It shall be noted and in contrast, a verb in the infinitive form in English, always starts with the word “to.” FIG. 16 is a diagram depicting an output display 2 showing two child nodes of the verb 12, one of which is a more expressive form of one of the two child nodes compared to the child node in FIG. 15. The second of the two big ideas is verb conjugation. Verb Conjugation involves the changing of the verb ending to identify who performed an action and when the action occurred. There are two things that one has to know about the conjugated form. First, “who” performed the action. The answer identifies the subject. Second, “when” the subject performed the action in, e.g., past tense, present tense or future tense. Conjugation does not answer the question “what” is being done. That is, conjugation does not tell us what the action is. The action is identified in the infinitive 42 form. The conjugated 44 form does tell the action but the additional information of the act of conjugating reveals the time of the action and “who” performed the action. Step 13 is first shown in FIG. 16. There are two steps to conjugating a verb. First, the verb ending, e.g., “ar,” “er,” and “ir.” Then, an appropriate ending is added based on a subject pronoun verb conjugation chart as provided in step 14 in FIG. 17. FIG. 17 is a diagram depicting an output display 2 showing determination of verb endings based on a subject pronoun 36. There are two things to know, i.e., the “same and different” methodology is applied to the chart. There are two important characteristics to consider. First, e.g., the endings of Spanish word “nosotros” for all verbs use their own “vowel ending.” That is, each ending for the word “stays true” to the verb. Second, “er” and “ir” verb endings share the same endings, except for “nosotros.” Using chart 46, the conjugated verb now identifies the subject and the time. FIG. 18 is a diagram depicting an output display 2 showing a step having been applied to form a complete sentence in step 15. There are again two things to ensure a complete thought. First, a sentence that is formed at this step must agree with the noun 10 and then, the verb must be conjugated.

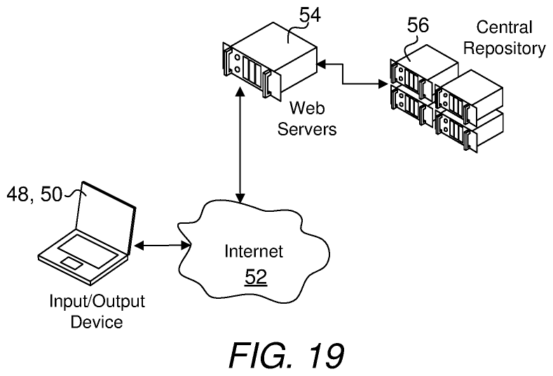

FIG. 19 is a block diagram depicting one embodiment of the hardware for carrying out the present system. The system includes an input/output device 48, 50, at least one web server 54 and a central repository 56, where all of these hardware communicate via the internet 52. A web application is provided in the input/output and monitoring devices 48, 50 accessible to a user or a manager. As will be appreciated by those skilled in the relevant art(s) after reading the description herein, in an aspect, the web application of devices 48, 50 execute on one or more web servers 54 providing one or more websites which send out web pages in response to Hypertext Transfer Protocol (HTTP) or Hypertext Transfer Protocol Secured (HTTPS) requests from remote browsers. Thus, such web servers 54 are able to provide a graphical user interface (GUI) to users of the input/output/monitoring devices 48, 50 or other devices utilizing the web application of the web servers 54 in the form of web pages. These web pages are sent to the input/output and monitoring devices 48, 50. An input, output or monitoring devices 48, 50 may be any one of these devices: computing device, desktop computer, laptop computer, notebook computer, mobile device, smart phone, personal digital assistant (PDA), electronic pad or like terminal devices where GUI screens can be displayed. In preparing the present system for use, a computer program configured to provide the screens disclosed elsewhere herein, is first loaded in a resident memory device of an input/output device 48, 50 and/or a remote central repository 56.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

What is claimed herein is:

1. A computer program for executing a display process configured for aiding a user in constructing a sentence in Spanish language, the computer program adapted to execute on a system including a processor, and a non-transitory machine-readable storage medium instructions that when executed, cause the processor to execute a display process comprising:
(a) arranging a series of slides comprising contents in a progressively more expressive manner, each slide depicting at least a portion of a binary tree, wherein at least one later slide of two consecutive slides of said series of slides comprises at least a pair of child nodes of a parent node of an earlier slide of said two consecutive slides; and
(b) associating a first button to a first function of said display process, said first button is configured to advance a display of an earlier slide to a display of a later slide and associating a second button to a second function of said display process, said second button is configured to roll back a display of a later slide to a display of an earlier slide,
whereby a user of said display process can look up at least two child nodes as related to a parent node on an earlier slide.

2. The computer program of claim 1, wherein said binary tree comprises two nodes characterized by a noun followed by a verb at a base level.

3. The computer program of claim 2, wherein said binary tree comprises two nodes characterized by an infinitive form and a conjugated form based on said verb.

4. The computer program of claim 2, wherein said binary tree comprises two nodes characterized by a gender and a number based on said noun.

5. The computer program of claim 4, wherein said binary tree comprises two nodes characterized by a masculine form and a feminine form based on said gender.

6. The computer program of claim 4, wherein said binary tree comprises two nodes characterized by a singular form of said noun and a plural form of said noun based on said number.

7. The computer program of claim 2, wherein said binary tree comprises two nodes characterized by an article and an adjective attached to said noun.

8. The computer program of claim 7, wherein a noun sub-sentence is configured to be formed with said adjective agreeing with said noun in said gender and said number.

9. The computer program of claim 7, wherein said article comprises two nodes characterized by an indefinite article and a definite article.

10. The computer program of claim 9, wherein a noun sub-sentence is configured to be formed according to a string selected from the group consisting of said indefinite article and said adjective agreeing with said noun in said gender and said number and said definite article and said adjective agreeing with said noun in said gender and said number.

11. The computer program of claim 10, wherein said noun sub-sentence is substituted with a subject pronoun.

12. The computer program of claim 11, wherein a verb ending of said verb is determined based on said subject pronoun.

13. The computer program of claim 11, wherein said binary tree comprises two nodes characterized by a singular form and a plural form based on said subject pronoun.

14. The computer program of claim 1, wherein said at least a pair of child nodes are disposed at different colors to aid the user in distinguishing said at least a pair of child nodes.

15. A computer readable medium storing a program causing a computer to execute a display process for teaching Spanish language, said display process comprising:
(a) arranging a series of slides comprising contents in a progressively more expressive manner, each slide depicting at least a portion of a binary tree, wherein at least one later slide of two consecutive slides of said series of slides comprises at least a pair of child nodes of a parent node of an earlier slide of said two consecutive slides; and
(b) associating a first button to a first function of said display process, said first button is configured to advance a display of an earlier slide to a display of a later slide and associating a second button to a second function of said display process, said second button is configured to roll back a display of a later slide to a display of an earlier slide,
whereby the user can look up elements of each of at least two child nodes as related to a parent node on an earlier slide.

16. The computer readable medium of claim 15, wherein said binary tree comprises two nodes characterized by a noun followed by a verb at a base level.

17. The computer readable medium of claim 15, wherein said binary tree comprises two nodes characterized by an infinitive form and a conjugated form based on said verb.

18. The computer readable medium of claim 15, wherein said binary tree comprises two nodes characterized by an article and an adjective attached to said noun.

19. The computer readable medium of claim 18, wherein a noun sub-sentence is configured to be formed with said adjective agreeing with said noun in said gender and said number and said article comprises two nodes characterized by an indefinite article and a definite article.

20. The computer readable medium of claim 19, wherein a noun sub-sentence is configured to be formed according to a string selected from the group consisting of said indefinite article and said adjective agreeing with said noun in said gender and said number and said definite article and said adjective agreeing with said noun in said gender and said number.
